(19) United States
(12) Patent Application Publication
(10) Pub. No.: US 2005/0125386 A1
(43) Pub. Date: Jun. 9, 2005

(54) Method and apparatus for finding the location of items within a shopping venue

(76) Inventor: Roger M. Diebold, Barrington, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/728,625

(22) Filed: Dec. 5, 2003

(51) Int. Cl. G06F 7/00; G06F 17/30; G06F 17/00

(52) U.S. Cl. 707/3; 707/104.1

(57) ABSTRACT

An apparatus and a method that permits consumers to find sought after items in a retail store by accessing a computer provided with a data base containing names of items for sale and the locations of those items is described. The customer enters the name of the sought after item with a keyboard, and on execution of the program, the computer accesses a data base and returns the location of the item in the store on a screen. The database for the computer is made up using a second computer program, or a subprogram of the first program, and consists of entries of product names and their individual locations within the store.

### BACKGROUND OF THE INVENTION

The present invention relates generally to a computer program that gives a customer a rapid and simple means of searching for product locations within a shopping venue. More specifically, the present invention provides a customer with an easy entry interface to search based on the name of the sought after item, and a simple display describing the location of that item. The invention, unlike existing computer programs, has the capability of being direct and simple enough in its operation that it can be used by an unskilled operator with little or no previous experience in the operation of computers.

Contemporary retail outlets are sometimes so large that customers often have a difficult time finding the items they are intending to purchase. Additionally, stores often contain merchandise stacked on shelving to heights of tens of feet adding further to the difficulty to finding items. With the large floor space and wide variety of products available in such stores, searching for a desired item is often time consuming and frustrating for the consumer. Even in small or medium size retail stores the same problem exists for patrons that are unfamiliar with the layout of the store.

An attempted solution to the problem of finding products is to post product names or categories of products on the aisles where they are to be found. This solution is only partially successful owing to the variety of products stores typically sell. Additionally, since stores can be so large, all of the signs on the aisles cannot be viewed at the same time. For the customer, the usual solution to the difficulty is to ask a salesperson or other store employee for the location of the desired item. From the point of view of the customer, an unassisted search for a desired item is time consuming and frustrating, and makes shopping an unpleasant chore. From the point of view of the store owner, the time lost in having employees direct consumers to sites within a store has three major effects that negatively affect profitability. The first is that personnel must be hired in sufficient numbers to be visible to consumers so that they are available for questions about product location. Second, sales personnel must be sufficiently knowledgeable to direct customers to the whereabouts of the sought after item, which involves training, or, at least some period of employment sufficiently long to enable them to be become familiar with the locations of products. Third, store personnel carrying out their duties are continually interrupted in their work by customers asking questions, which results in lower work productivity. All three of these factors result in increased labor costs.

In principle, existing computer programs could be configured to provide product name and location information. Microsoft® “Word” or “Excel”, and other similar word processing programs have a “search” option that permits an operator to search a data base. Product and location data can also be entered and stored in such programs. However, the drawback of such programs for use in a retail store for customer use is that they are not specially configured to retrieve information from data bases in a rapid manner with a simple viewing feature. More importantly, they require the operator to be familiar with the details of their operation. The display in such programs, which is typically appropriate for viewing the contents of a document or a list of items in rows, is too complex for simple viewing and easy operation. A customer untrained in the use of a particular word processing or spreadsheet program would hardly trade the inconvenience of physically meandering through a store searching for a product with the more recalcitrant and impenetrable problem of deciphering the operation of a computer program with which he is not familiar.

There have been previous applications of computer technology for retail shopping. O'Hagen et al. in U.S. Pat. No. 6,595,417 describes mobile computers, a wireless connection to a host computer, and a bar code reader. The computer is connected to the internet to access data from a manufacturer's product data. The customer can scan products found at the store to access information relating to the product. A number of computerized devices for issuing and linking coupons to products in stores have been described as in Begum et al. in U.S. Pat. No. 5,420,606; Shultz in U.S. Pat. No. 5,483,049; Counts in U.S. Pat. No. 5,192,854; Powell in U.S. Pat. No. 5,890,135; Powell in U.S. Pat. No. 6,243,687; and Powell in U.S. Pat. No. 6,112,988. Computerized checkout systems, some issued to individual shoppers, and which use radio wave linkage to computers for price, known as “point of sale devices” include those described by Kumar in U.S. Pat. No. 5,294,782 and Tracy et al. in U.S. Pat. No. 6,550,672. Tracy and coworkers describe a computerized self-checkout system with a portable terminal having a code reader and interface such as a web browser. Pricing, instructions, and help associated with a product are all made available on their system. Conzola et al. in U.S. Pat. No. 6,497,367 describe a computerized system that uses the barcodes within a store to assist a visually impaired person in finding his position in the store and to assist the individual in finding an optimum path to a new location in the store.

Vela et al. U.S. Pat. No. 5,630,068 describe a communication system for linking shopping carts (or other merchandise collection devices) to a central computer data bank and transmitter that is activated by the consumer to prompt information regarding advertisements pertaining to products, or the location of the shopping cart and location of the item sought through a display of the floor plan or layout of the marketing area. The invention comprises a communication system for a “relay unit” that is movable and is to be carried or transported through the store by the shopper, and which gains access to a data base in a computer to display information regarding the merchandise. Baus in U.S. Pat. No. 4,750,151 describes an apparatus for information retrieval that has a single common inquiry unit connected to a number of display units. The central feature and claim of Baus' invention is a means for retrieval of information actuated by touching a symbol carrier panel. The panel is such that items are symbolically displayed. The panel can also be actuated by touch to return product information such as location in a store. Also claimed are output units that are mobile, and such units that are mounted on carts. According the invention, after actuating the touch panel, the location of items sought is communicated to the shopper by a symbol carrier panel that displays the product location on a floor plan of a retail store.

While Vela et al. describe an information retrieval device that is, in principle, superior to that described here from the point of view of quantity of information that can be supplied and convenience to the customer, in the opinion of the author, Vela's invention suffers from technical complexity and high capital costs that are not warranted by the advantage that accrues to its use. There would appear to be large costs incurred in implementation and servicing of a system that would bring only marginal benefits to the owner of the invention. Insofar as Baus' invention is concerned, it would appear to be impractical, or at the very least, confusing to the customer, to have the hundreds or thousands of items for sale in a store displayed on a touch screen. Even though a visual map of a store with the location of the sought after item displayed would, in principle, be of value, its implementation requires programming a floor plan for every store in which the invention is used, a complication that, in the opinion of this author, renders the invention somewhat problematic for widespread usage.

### BRIEF SUMMARY OF THE INVENTION

In this regard, the present invention serves to provide a computer program different from existing spread sheet, word processing, or data retrieval programs that gives the customer a rapid and simple means of searching for product locations with an easy entry of the name of the sought after item, and a simple display describing the location of that item. The invention, unlike existing computer programs, has the capability of being direct and simple enough in its operation that it can be used by an unskilled operator with little or no previous experience in the operation of computers.

It is therefore an object of the invention to provide a means whereby a customer can access a computer containing a database and appropriate program that permits the customer to determine the location of a desired item without the assistance of store personnel. The purpose of the device is to assist customers in finding the location of a desired item, while saving the merchant the expense of hiring personnel. It is an object of the program to provide a rapid and simple means of accessing product and location information. It is an object of the invention to provide a simple method for entering the name of a sought after product and a simple means of displaying the required information about the location of the product in a manner so that the device can be used by operators unskilled in the operation of computers or associated computer technology.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is a schematic diagram of an exemplary apparatus used to implement the system of the present invention.

### DETAILED DESCRIPTION OF THE INVENTION

Referring now to the drawing, the apparatus pertaining to the invention generally comprises a computer 1, a monitor or other similar display device 2, a keyboard for entry of information into the computer 3, and an interactive device for entering data fields via the monitor, commonly known as a “mouse” 4. Devices 1 through 4 are interconnected to make up an integrated computer system where data can be entered through the keyboard and mouse, a computer program executed, and information displayed on the monitor 2. Computer programs that accept product and location data that make up the data base, and programs that permit the operator to access the information in the data base are stored in the computer, along with the other programs that normally make a computer function.

The computer is equipped with three programs, which will be referred to here as Programs I, II, and III, although the three programs can be incorporated into a single program that provides the same functions. Program I is written so that product names and locations can be entered so as to make up a data base used for Program II. Program III is used to check the entries in Program I to ensure that they have been entered correctly and that Program II will execute as directed. Programs I and III are used by store employees or trained personnel; Program II is used by customers. Names entered into Program I can be generic names, or can include brand names, or other product information, as well. Also entered into Program I are the locations of the products within the store.

In one preferred embodiment of the invention, Program I acquires a data base by having computerized store inventories loaded into the program. The products are then linked to their locations in the store by manually entering such information, or, if such information is available as computerized data, by loading the information from the appropriate data base. In a second preferred embodiment of the invention, Program I takes in data of product name and the location or locations of that product within the store by manual data entry. It is envisioned that a mobile computer would be moved from point to point in a store with an employee entering the name of the product and the location within the store. An example of data produced by Program I, acquired by either of the two embodiments described above, for a grocery store would be:

TABLE I

| Item | Aisle | Position along isle | Side | Shelf |
|---|---|---|---|---|
| Soup | 3 | ½ way | left | top |
| Mustard | 2 | end | right | bottom |
| Fritos | 4 | ¼ way | right | third |

More complicated, extensive, or complete data can be entered depending on the nature of the store, and how precisely the product or location data are to be specified. Data for hardware and building supply stores would be similar to that in Table I, but perhaps more extensive. Program I data for furniture, auto parts, electronics, movie rental, or general merchandise stores can be similar to that for the grocery store. In operation of the invention, the first step is to make a data base of product and location using Program I. The data base in Program I is checked for errors through use of Program III. After checking the contents of Program I, the contents of Program I are loaded into Program II, providing the data base for its operation. Program I is no longer used except to update the inventory list of items in the store or update locations.

Program II is used by the customer. The list of first entries, “Item”, makes up the search field; the list of locations is the “location” field. In practical operation of the invention, the computer is located in a conspicuous place in the store; a sign describes the function of the device. The consumer operates the computer through Program II by entering the sought after item in a text box on the screen of the computer using the keyboard. On pressing the enter command, Program II executes, returning the aisle, the position along the isle, the side of the isle, and which shelf the item is located, or any other location data that is deemed necessary. The location information is displayed on the screen of the monitor in a manner so that it is clear to the operator, giving straightforward directions to the location of the sought after item. In one embodiment of the invention, a printer is used along with the monitor to provide written instructions as to the location of the sought after item.

In another embodiment of the invention, for use in stores where multiple monitors are desired, is to link the computers, or the monitors themselves, together to a single computer configured to operate with multiple input and output stations so that only one data base is used in the central computer.

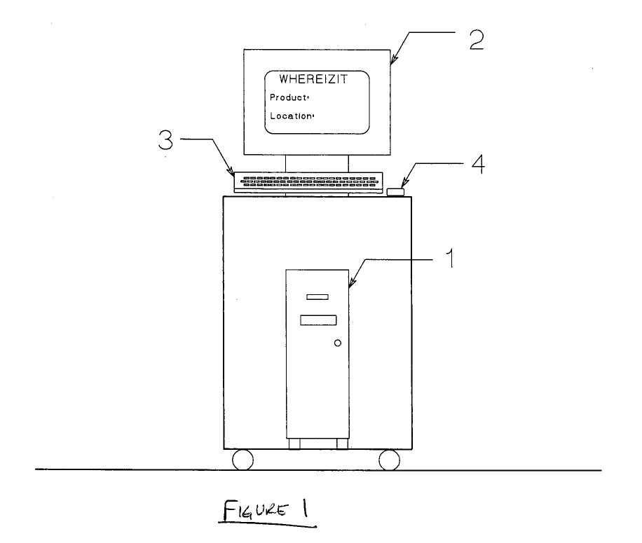

The apparatus that comprises the invention, as shown in FIG. 1, consists of a computer 1, a monitor 2, and a keyboard 3. One embodiment of the invention makes use of a “mouse” 4 for control of the computer. Another embodiment uses a printer 5 that prints out the location of the item sought.

Program I combines data, e.g. aisle, shelf, or distance down aisle, entered by the employees or skilled operators to make a string of data separated by delimiters together with the product name. The delimiters specify where an entry will be displayed in Program II. The strings are saved in a data file in the hard drive of the computer or an equivalent memory device. Data strings describing items and their locations in the store are produced for as many items in the store as deemed practical and useful. The data file that results by making entries in Program I resembles that produced by Microsoft Excel, and can be read by a number of contemporary word processing programs such as Microsoft Word, Excel, or Notepad, although this property is not essential for operation of the invention. The programming language for writing the three programs can be C, C⁺⁺, Labview, or most any other programming language that permits data entry, making a word match, and recalling data from a database.

Program I is designed to make a file of “item” and “location”. The program is configured to accept entry of an item name, and several entries of location data. The operator types in, or enters in whatever convenient manner, the item name, and the location data. When the data fields have been entered, the operator pushes a key, or operates the mouse to enter data into the database. Program I automatically formats the data so that delimiters are placed between the data entries so that the database is organized and can be read by Program II. The data in the database in one embodiment of the invention is a “string”, where string refers to alphabetical or numerical data that is stored, but which is not typically designed for mathematical calculations. An example of a line of the database produced by Program I, in one embodiment of the invention in the example for “soup” shown in Table 1 above would be:
Soup delimiter3delimiter½delimiterleftdelimitertoplinefeed

The delimiter in one embodiment could be a tab. The database is made of a plurality of entries as shown for the example of soup, with one entry followed by the next. The entire database in one embodiment of the invention is a single string made from individual strings describing single items and their locations.

Program III checks the entries in the data file produced by Program I to ensure that the requisite number of delimiters, data entries, and line delimiters have been entered for each item so that there will be no malfunction of Program II. Program III uses a Loop to check for the position of each delimiter and the presence of data entries giving a command to check a subsequent line of the file when the first line passes the test for the correct number and orders of items and delimiters. By checking each line, one at a time, the integrity of the entire file is ascertained. In one embodiment of the invention, Program III returns “correct” or “incorrect” to be displayed on the monitor that indicates the data are correctly entered with the appropriate delimiters.

Program II is written for customer use. The customer enters the name of the desired item into a text box displayed on the monitor using the keyboard and sends a command to the program to initiate execution of the program. In a preferred embodiment of the invention, execution of the program is initiated by pressing the ‘return’ key on the keyboard. In a preferred embodiment of the invention, the program verifies the data entry and then loads the database as a string into a subroutine. The subroutine searches for the entered item name within the database by searching for letters in the item name in the data base, and returns a confirmation of the item's presence or absence within the database along with location data. In the example above from the first line in Table I, one embodiment of the program searches the database for “s”, then “o”, then “u” and then “p”. If the item entered by the customer is found within the database, Program II returns the location data with the delimiters to a display subroutine of the program. In the display subroutine, the program searches for delimiters in the string and directs the data between the delimiters to the appropriate outputs on the monitor. Thus, in the example, the first delimiter marks the position of the aisle datum, which is the number 3. The program then displays the datum in a position on the monitor marked “aisle” so that the customer reads “aisle 3” on the monitor. The program then searches for the next delimiter indicating how far down the aisle the item is located and returns ½ to the display subroutine. By searching consecutive delimiters and data in the string of the database, the information entered in Program I is retrieved and displayed on the monitor.

If the item entered by a customer is not found within the database, a message is displayed on the monitor indicating that the item was not found.

The retrieved data need not be a series of words, but can be of a form to mark a spot where a product is located on a computer display of a floor plan of the store. The makeup of Programs I and II to write and read a pictorial data base include again data fields that mark the position of the item, delimiters, a matching subroutine, and a display subroutine, but the output is directed to a monitor with a floor plan of the store. The nature of the data is somewhat different in the case of pictorial data so that location data is not stored as words, but rather with codes that mark the position of the item on a store map.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A method for a customer operated search system to provide the location of retail products within a venue comprising:
providing an electronic storage device, said storage device including stored information related to retail products and information relating to the location of said retail products within the venue;
providing a computer terminal, said computer terminal being connected to a computer network wherein said computer terminal can access said electronic storage device, said computer terminal including an input device and a display device;
entering a query regarding a retail product on said computer terminal utilizing said input device;
retrieving the location data related to the queried retail product from said electronic storage device; and
displaying said location data on said display device.

2. The method of claim 1, wherein said stored information is stored in a computerized data base.

3. The method of claim 2, wherein said computerized database is operated as one computer program at one location and said query is performed by a second computer at a second location via said computer network.

4. The method of claim 1, wherein said input device includes a keyboard and a computer mouse.

5. A system for facilitating a customer operated search to provide the location of retail products within a venue comprising:
an electronic storage device, said storage device including stored information related to retail products and information relating to the location of said retail products within the venue; and
at least one computer interface terminal, said interface terminal being connected to a computer network wherein said computer terminal can access said electronic storage device, said computer terminal including an input device and a display device,
wherein said customer enters a query regarding a retail product on said computer interface terminal utilizing said input device, said computer interface retrieves said location data related to the queried retail product from said electronic storage device, and said location data is displayed on said display device.

6. The system of claim 5, wherein said at least one computer interface terminal is a plurality of computer interface terminals all connected to said electronic storage device via said computer network.

7. The system of claim 6, wherein said stored information is stored in a computerized data base.

8. The system of claim 5, wherein said stored information is stored in a computerized data base.

9. The system of claim 5, wherein said computerized database is operated as one computer program at one location and said query is performed by a second computer at a second location via said computer network.

10. The system of claim 5, wherein said input device includes a keyboard and a computer mouse.
